(19) United States
(12) Patent Application Publication
(10) Pub. No.: US 2005/0124462 A1
(43) Pub. Date: Jun. 9, 2005

(54) Optimized wiping of vehicle brakes

(76) Inventors: Jochen Wagner, Moeglingen (DE); Guenter Holzhaeuser, Weil Der Stadt (DE); Stefan Bayer, Schwieberdingen (DE); Mario Schmidt, Freiberg (DE); Udo Mayer, Stuttgart (DE)

Correspondence Address: KENYON & KENYON, ONE BROADWAY, NEW YORK, NY, 10004, US

(21) Appl. No.: 10/996,482

(22) Filed: Nov. 24, 2004

(30) Foreign Application Priority Data
Nov. 26, 2003 (DE) 103 55 258.8

(51) Int. Cl. B60K 41/20

(52) U.S. Cl. 477/182

(57) ABSTRACT

A method for wiping the brakes of a motor vehicle under wet conditions is described, whereby the brake pads are applied to the braked element under low pressure. This wiping of the brakes is hardly noticeable or not noticeable at all when the wiping operation is triggered in an instant in which the change in the accelerator pedal position or the change in the vehicle velocity exceeds a predefined threshold value.

### FIELD OF THE INVENTION

The present invention relates to a method and a device for wiping a vehicle brake.

### BACKGROUND INFORMATION

A water/dirt film, which impairs the braking effect of the brake, forms on the brake disks of a vehicle brake in wet conditions. The braking distance may thus be significantly lengthened under wet conditions.

To improve the braking effect, it is known to briefly apply the brake pads to the brake disks under low pressure, thus simply wiping away the water/dirt film. It is common in known braking systems to carry out a wiping operation either after a predefined time has elapsed, e.g., every three to five minutes, or after a predefined distance has been covered, e.g., every five kilometers.

The vehicle decelerates slightly due to the wiping operation, especially during slow driving at a constant speed. This is relatively easily noticeable to the driver and may irritate the driver.

### SUMMARY OF THE INVENTION

Therefore, it is an object of the present invention to implement a wiping operation in such a way that the driver may hardly notice it or not notice it at all.

To select the point in time at which a wiping operation is triggered in such a way that it coincides with the driver pressing the accelerator pedal or with a velocity change of the vehicle (positive or negative acceleration) is an essential aspect of the present invention. During a velocity change, the vehicle acceleration is superposed by the vehicle deceleration caused by the wiping operation. A wiping operation is far less noticeable to the driver in such a driving situation than in a constant driving situation since the driver expects a velocity change anyway.

A wiping operation may alternatively also be triggered when the driver in fact presses the accelerator pedal, but no velocity change or only a minor velocity change takes place as in the event, for example, of the driver pressing the accelerator pedal while the vehicle continues moving uphill. A wiping operation is also far less noticeable to the driver in this situation than, for example, when driving on a flat stretch of road at a constant speed.

A wiping operation (in addition to other predefinable conditions) is preferably triggered under the condition that the change in the accelerator pedal position and/or the change in the vehicle velocity exceed(s) predefined threshold values.

Different variables, from which the mentioned variables are derivable, may be used as a measure for the change in the accelerator pedal position as well as for the change in the vehicle velocity. As a result, the acceleration may be determined, for example, from the signal of wheel speed sensors or from the signal of an acceleration sensor. An engine torque or the change in the engine torque, a drive torque or the change in the drive torque, or an engine speed or the change in the engine speed may optionally be used for checking whether the change in the vehicle velocity exceeds a predefined threshold value. The change in the accelerator pedal position may be determined, for example, via a position sensor or an angle sensor, situated at the accelerator pedal, or on the basis of an analog variable, such as the change in throttle position, for example.

According to a preferred embodiment of the present invention, at least two variables, from which the change in the accelerator pedal position or the change in the vehicle velocity is derivable, are monitored with respect to the threshold value, and a wiping operation is triggered when at least one of the variables exceeds a predefined threshold value. Two complementary strategies are thus implemented, and it is ensured that a wiping operation is triggered at the right moment.

The threshold values relevant for triggering the wiping operation are preferably variable and dependent on the driving situation. Triggering of a wiping operation may thus be adapted to different driving situations. The threshold value for the change in the accelerator pedal position is preferably dependent on the vehicle velocity or the threshold value for the change in the vehicle velocity is dependent on the accelerator pedal position. Different threshold values for the change in the vehicle velocity are also possible, depending on whether the change is positive or negative.

During a longer drive under relatively constant driving conditions, it is sensible, for purely preventive considerations, to trigger a wiping operation even when the monitored variables (accelerator pedal change/acceleration) do not exceed the particular threshold value, but a different condition is met which triggers a routine wiping operation. It is therefore proposed to carry out a wiping operation when a predefined time has elapsed since the last braking operation or when the vehicle has covered a predefined distance. The brakes are thereby wiped at least at regular intervals.

A regular wiping operation may be carried out, for example, using different parameters (pressure, length of time), than a wiping operation above the predefined threshold values for the accelerator pedal change/acceleration, i.e., the brakes may be wiped, for example, using a lower pressure over a longer period of time. This is far less noticeable to the driver under constant driving conditions.

### BRIEF DESCRIPTION OF THE DRAWING

FIG. 1 shows a flow chart of the essential method steps of an optimized wiping method;

FIG. 2 shows a system for wiping a vehicle brake, and

FIG. 3 shows a disk brake known from the related art.

### DETAILED DESCRIPTION

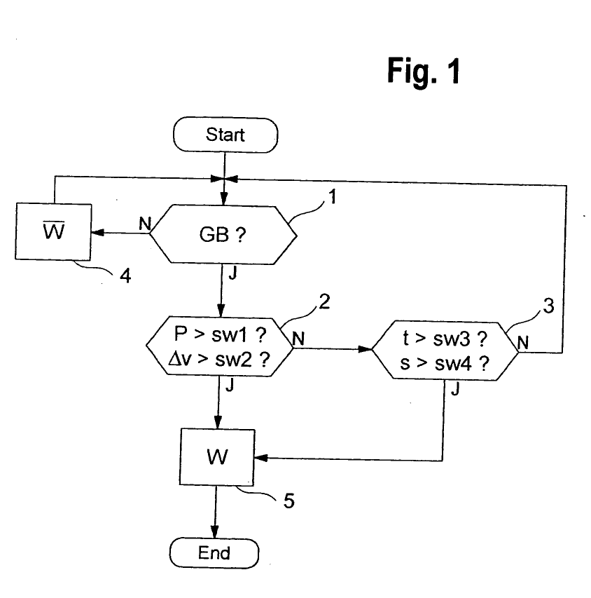

FIG. 1 shows the essential method steps which are executed up to the triggering of a brake wiping operation. It is initially checked in step 1 whether basic preconditions are present to carry out a wiping operation (step 5) at all. One of the basic preconditions is the presence of wetness. Wetness may be detected, for example, using a moisture sensor or another variable representing the condition “wetness.” Activation of the windshield wiper may indicate the presence of wetness, for example.

A further basic precondition, for example, may be a minimum speed (e.g., 50 km/h) which the vehicle must have to trigger a wiping operation.

In addition, further criteria such as “the brakes are not operated at the moment or the accelerator pedal is pressed at the moment” may be predefined.

If necessary, the aforementioned criteria or other criteria may be jointly or alternatively linked.

If the basic preconditions in step 1 are not met (N), the method moves to step 4 and no wiping operation takes place. The routine then starts again.

If the predefined basic preconditions in step 1 are met (case J), further conditions are checked in step 2 which cause the triggering point of a wiping operation to fall into an advantageous driving situation. Such an advantageous driving situation exists in particular when the vehicle is subjected to a velocity change or when the driver presses the accelerator pedal. The wiping operation is far less noticeable to the driver in such a driving situation than in a constant driving situation, since the driver expects a velocity change anyway.

Therefore, it is checked in step 2 whether the change in the accelerator pedal position or the change in the vehicle velocity exceeds a particular predefined threshold value sw1, sw2.

If the answer is yes, a wiping operation is then triggered in step 5 which the driver may hardly notice as such or not notice it at all.

Any variables, from which the change in the accelerator pedal position or the change in the vehicle velocity is derivable, may be used as a measure for the change in the accelerator pedal position or for the change in the vehicle velocity. The accelerator pedal position may be determined, for example, using an accelerator pedal sensor or on the basis of the throttle position. The change in the vehicle velocity may be determined, for example, using wheel speed sensors, an acceleration sensor, via the engine torque, the drive torque or the engine speed.

In order to determine the triggering point more accurately and more reliably, preferably two or more of these variables are analyzed and monitored with respect to their threshold values. A wiping operation is triggered when at least one of the monitored variables exceeds a predefined threshold value.

If the additional conditions in step 2 are not met, it is checked in step 3 whether another condition is possibly met. This other condition is met, for example, when a length of time t since the last braking operation is greater than a threshold value sw3 or a distance, which the vehicle has covered since the last braking operation, is greater than a threshold value sw4. It may be ensured in this way that, during constant driving, the brakes are at least wiped at regular intervals. If one of the other conditions in step 3 is met, a wiping operation is initiated in step 5. Otherwise (N), the routine restarts at step 1.

A wiping operation under the conditions of step 2 is preferably carried out using other parameters than a regular wiping operation according to step 3. A wiping operation below predefined threshold values sw1, sw2 is carried out, for example, using a lower pressure over a longer length of time than above threshold values sw1, sw2.

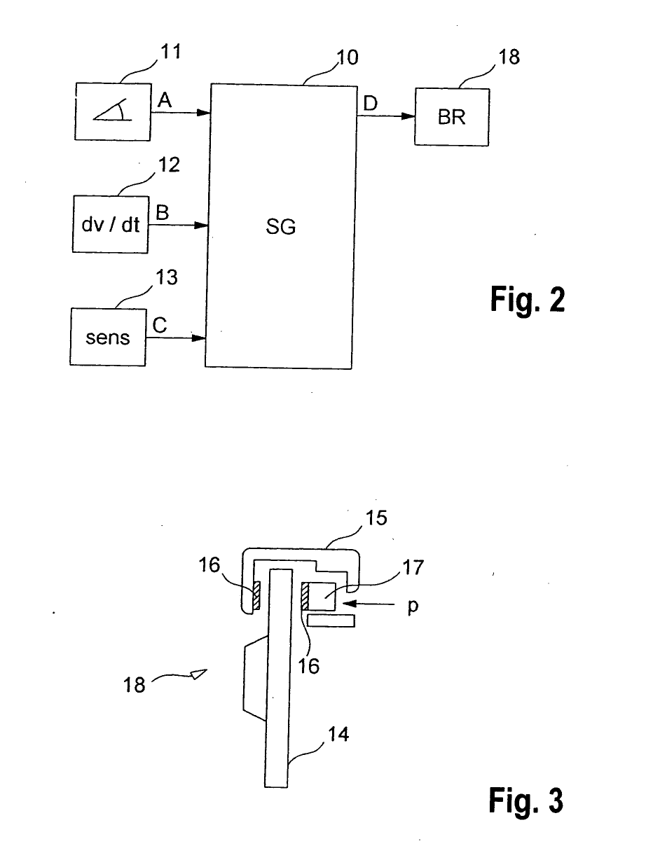

FIG. 2 shows a system for wiping brakes under wet conditions. The system includes a control unit 10 to which different sensor signals A, B, C from sensors 11, 12, 13 are supplied. Control unit 10 analyzes the signals and activates a brake 18 when the conditions of step 2 or step 3 are met.

Sensor 11 is a sensor for determining the accelerator pedal position, and sensor 12 is an acceleration sensor for determining a velocity change. Block 13 represents a number of sensors, additional variables, relevant for the above-described method, such as the condition “wetness,” the vehicle velocity, a brake activation, etc., being derivable from signals C of such sensors. Sensors 12 may thus include, for example, wheel speed sensors, a moisture sensor, a brake activation sensor, etc.

Control unit 10 processes sensor signals A, B, C, executes the threshold value comparisons described in FIG. 1, and controls the brake wiping operation, if needed.

FIG. 3 is merely used to illustrate a conventional disk brake. This disk brake essentially includes a brake caliper 15 in which a brake clip 17 together with a brake pad 16 are movably situated. Other brake pad 16 is situated on brake caliper 15 on the opposite side of brake disk 14. By applying hydraulic pressure p, brake pads 16 are pressed against brake disk 14 in order to execute a wiping operation or braking operation. The brake pressure during a wiping operation amounts to a few bar, 5 bar, for example.

### Reference Numerals

1-5 method steps
10 control unit
11 accelerator pedal sensor
12 acceleration sensor
14 brake disk
15 brake caliper
16 brake pads
17 brake clips
18 disk brake

1. A method for wiping a brake of a motor vehicle under wet conditions, comprising:
applying brake pads to a braked element under low pressure;
triggering a wiping operation when one of a change in an accelerator pedal position and a change in a vehicle velocity exceeds a predefined threshold value.

2. The method as recited in claim 1, wherein:
the braked element includes a brake disk.

3. The method as recited in claim 1, wherein a first variable, from which one of the change in the accelerator pedal position and the change in the vehicle velocity is derivable, is used as a measure for one of the change in the accelerator pedal position and in the vehicle velocity.

4. The method as recited in claim 3, further comprising:
determining at least one second variable from which one of the change in the accelerator pedal position and in the vehicle velocity is derivable; and
triggering the wiping operation only when at least one of the first variable and the at least one second variable exceeds the predefined threshold value.

5. The method as recited in claim 1, wherein the wiping operation is triggered one of when a predefined length of time is exceeded and when the vehicle has covered a predefined distance without braking.

6. The method as recited in claim 1, wherein a threshold value for a change in an accelerator pedal position is dependent on one of the accelerator pedal position and the vehicle velocity.

7. The method as recited in claim 6, wherein different threshold values are provided, depending on a direction of the change in one of the accelerator pedal position and in the vehicle velocity.

8. The method as recited in claim 3, wherein a wiping operation carried out below the predefined threshold value is executed using other parameters than a wiping operation above the predefined threshold value.

9. A device for wiping a brake of a vehicle under wet conditions in which brake pads are applied to a braked element under low pressure, comprising:
a sensor for at least one of detecting a change in an accelerator pedal position of the vehicle and detecting a change in a vehicle velocity;
a control unit; and
at least one brake, wherein:
the control unit a wiping operation to be executed when one of the change in
the accelerator pedal position and the change in the vehicle velocity exceeds a predefined threshold value.

10. The device as recited in claim 9, wherein the braked element includes a brake disk.

11. The device as recited in claim 9, wherein:
the wiping operation is triggered one of when a predefined length of time is exceeded and when the vehicle has covered a predefined distance without braking.
